(19) United States
(12) Patent Application Publication
(10) Pub. No.: US 2010/0316189 A1
(43) Pub. Date: Dec. 16, 2010

(54) OBJECT SCANNING SYSTEM

(75) Inventor: Anthony W. Davis, St. Paul, NM (US)

Correspondence Address: 3M INNOVATIVE PROPERTIES COMPANY, PO BOX 33427, ST. PAUL, MN, 55133-3427, US

(73) Assignee: IMTEC CORPORATION, Ardmore, OK (US)

(21) Appl. No.: 12/740,247

(22) PCT Filed: Oct. 28, 2008
(86) PCT No.: PCT/US2008/081462

§ 371 Date: Aug. 27, 2010

Related U.S. Application Data
(63) Continuation-in-part of application No. 12/259,276, filed on Oct. 27, 2008, now abandoned.
(60) Provisional application No. 60/983,212, filed on Oct. 28, 2007.

(51) Int. Cl. G01N 23/04

(52) U.S. Cl. 378/62

(57) ABSTRACT

In an embodiment, a method of using a linear path to transmit X-rays through, sequentially, an object, a scintillator, a lens and an imaging sensor is described. In a further embodiment, an X-ray scanner that uses an amorphous silicon detector plate to detect photons transmitted from a scintillator with lens or fiber coupling is described. In addition, a method for utilizing an amorphous silicon area detector to create digital radiographs of parts which are themselves larger than the active area of the amorphous silicon array is described.

### CROSS REFERENCE TO RELATED APPLICATIONS

This application is a national stage filing under 35 U.S.C. 371 of PCT/US2008/081462, filed Oct. 28, 2008, which claims priority to U.S. Provisional Application No. 60/983,212, filed Oct. 28, 2007, the disclosure of which is incorporated by reference in its entirety herein.

### FIELD OF THE INVENTION

The present invention relates generally to the field of electronic and digital radiography and computed tomography scanning systems. More specifically, the invention relates to a scanning unit with the capability to transmit and receive X-rays.

### BACKGROUND

It is well known in the field of radiography, that X-rays produced by an X-ray source may be used for imaging by passing through an object, then interacting with a scintillator, thus producing visible light photons. The information acquired from X-rays passing through an object may be converted into light by passing through a scintillator. In some applications, the scintillator may be located adjacent to an x-ray capturing device such as a camera or an amorphous detector. In other solutions the scintillator is located near the object, creating space between the scintillator and the imaging device. If the imaging device is a CCD (charge-coupled device) sensor or other crystalline silicon sensor, the X-rays can damage the device. In some solutions, a mirror may be placed to divert or reflect the light to a camera not in the direct line of the X-rays. However, these solutions, by themselves, invariably create blurring and distortion the resulting images. Also, efforts to shield the CCD sensor from scatter radiation may involve additional shielding and dense optical glass which add weight to the assembly and still stray X-ray photons cause image degradation and damage to the CCD sensor.

### SUMMARY

In an embodiment, a method of using a linear path to transmit X-rays through, sequentially, an object, a scintillator, a lens and an imaging sensor is described. In a further embodiment, an X-ray scanner that uses an amorphous silicon detector plate to detect photons transmitted from a scintillator with lens or fiber coupling is described. In addition, a method for utilizing an amorphous silicon area detector to create digital radiographs of parts which are themselves larger than the active area of the amorphous silicon array is described.

In one embodiment, a scanning apparatus is disclosed for imaging an object of interest that includes an X-ray source capable of producing and transmitting X-rays through the object of interest; a scintillator that converts X-rays to visible light; a lens to focus the visible light into a volume of information; and a capturing device to capture the volume of information.

The present disclosure describes a unique X-ray system that allows the array of the capturing device to be inline with the X-ray source. The array is protected from stray X-ray photons that might normally damage the array. The system allows objects greater in size than the array to be imagined and digitally displayed.

These and other features, aspects and advantages of the present invention will become better understood with reference to the following drawings, description, and claims. For a better understanding of the invention, its operating advantages and the specific aspects of its uses, reference should be made to the accompanying drawings and descriptive matter in which there are illustrated preferred embodiments of the invention. The foregoing has outlined some of the more pertinent aspects of the invention. These aspects should be construed to be merely illustrative of some of the more prominent feature and applications of the present invention. Many other beneficial results can be attained by applying the disclosed invention in a different manner or by modifying the invention within the scope of the disclosure.

### DESCRIPTION OF DRAWINGS

FIG. 1 is a schematic illustration of an embodiment of the scanning system.

FIG. 2 is a schematic illustration of an embodiment of the scanning system.

### DETAILED DESCRIPTION

The method and apparatus of imaging objects of interest envisioned by the present invention differs greatly both in function and structure from past attempts to scan objects with X-rays. The present invention provides the novel advantage of utilizing a direct line of transmitting X-rays through an object of interest, converting them to visible light, focusing the visible light through an optical system, and capturing the magnified visible light on a radiation-tolerant plate such as an amorphous silicon plate, all in a direct line with X-rays and allowing imaging of objects larger than the detector array.

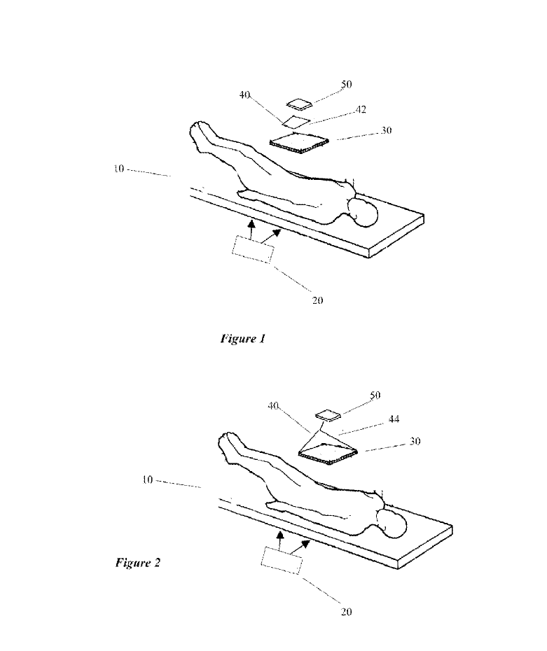

An embodiment of the present invention is illustrated in FIG. 1. The imaging system 10 of an embodiment of the present invention includes at least the following components: X-ray source 20, scintillator 30, optical system 40 and flat panel display 50.

The X-ray source 20 includes well known x-ray sources that are capable of providing X-rays through an object to the scintillator.

The scintillator 30 absorbs the X-rays and converts them into visible light photons that then pass onto the photodiode array of the capturing detector. The scintillator 30 is made from gadolinium oxysulfide or caesium iodide or other known materials for converting the X-rays into visible light photons.

The optical system 40 is preferably a lens 42 that focuses the photons from the scintillator 30 to the imaging panel 50. The lens 42 magnifies the visible light photons received from the scintillator 30 for transmission to the capturing detector 50. The lens can transmit those magnified photons directly to the detector or through an optical fiber to the detector.

The capturing detector 50 can be a flat panel amorphous silicon photodiode array or other known capturing device. The amorphous silicon photodiode array consists of a sheet of glass covered with a thin layer of silicon that is in an amorphous state. The silicon has been imprinted with millions of transistors arranged in a highly ordered array. Each of these thin film transistors (TFTs) are attached to a light-absorbing photodiode making up an individual pixel (picture element). Photons striking the photodiode are converted into two carriers of electrical charge, called electron-hole pairs. Since the number of charge carriers produced will vary with the intensity of incoming light photons, an electrical pattern is created that can be swiftly converted to a voltage and then a digital signal, which is interpreted by a computer to produce a digital image. Other types of capturing detectors can be a CCD sensor, camera or other devices.

In use, the X-ray source 20 transmits the X-ray radiation through the object to be imaged to the scintillator 30. The scintillator 30 converts the X-ray radiation into visible light photons that are further transmitted to the lens 42. The lens 42 then magnifies the visible light photons and transmits those magnified light photons to the capturing device. The capturing device, such as a flat panel amorphous silicon photodiode array, CCD sensor or camera, converts those light photons into a digital image.

This allows the detector 50 to be aligned directly inline with the X-ray source without damage to the detector from the stray X-ray photons. The system also does not require additional dense optical glass or radiation shielding to protect the detector from stray X-ray photons.

The use of the lens 42 can also be used to reduce the size of the light photons from the scintillator 30. The reduction of the light photons allows objects of greater size than the detector array to be X-rayed. The overall size of the object is reduced by the lens which allows the object to be fully shown on the display. This reduces the number of X-rays that might be required in order to X-ray a larger area.

Another embodiment of the present invention is illustrated in FIG. 2. This embodiment is similar to the embodiment of FIG. 1 discussed above, but uses a fiber optic coupling instead of or in combination with the lens 42. The fiber optic coupling receives the visible light photons directly from the scintillator 30 and transmits those photons directly to the capturing device array. This provides the benefits of allowing objects greater in size than the array as well as protecting the array from stray X-ray photons.

One application for the present invention is for use with medical imaging. Examples of such applications include creating orthodontic or prosthetic dental components, and creating surgical stints. It is to be understood that the present invention may also be used in any application requiring the use of an X-ray to create a digital image.

While various embodiments of the present invention have been described, additional variations and modifications in those embodiments may occur to those skilled in the art once they learn of the basic inventive concepts. Therefore, it is intended that the appended claims shall be construed to include both the disclosed embodiments and all such variations and modifications as fall within the spirit and scope of the invention.

1. An X-ray apparatus for imaging an object of interest comprising:
an X-ray source capable of producing and transmitting x-rays through the object of interest;
a scintillator that converts the X-rays to visible light;
an optical system to focus the visible light into a volume of information; and
a capturing device to capture the volume of information.

2. The X-ray apparatus of claim 1 wherein said optical system includes:
a lens for focusing the visible light to said capturing device.

3. The X-ray apparatus of claim 1 wherein said optical system includes:
a lens for magnifying the visible light to said capturing device.

4. The X-ray apparatus of claim 1 wherein said optical system includes:
a lens for reducing the visible light to said capturing device.

5. The X-ray apparatus of claim 1 wherein said optical system includes:
an optic fiber for transmitting the visible light to said capturing device.

6. The X-ray apparatus of claim 1 wherein said apparatus further includes:
said capturing device placed directly in line with the path of the X-rays.

7. The X-ray apparatus of claim 1 wherein said apparatus further includes:
said capturing device folded with mirrors for compactness.

8. The X-ray apparatus of claim 1 wherein said apparatus further includes:
said capturing device folded with said optical device for compactness.

9. The apparatus from claim 1 wherein said capturing device includes:
an amorphous silicon detector plate.

10. The apparatus in claim 1 wherein the capturing device includes:
a flat panel sensor off-set and using an extended field of view from transmissions sent by said X-ray source.

11. A method for imaging an object using an X-ray apparatus, said method comprising the steps of:
providing an X-ray source for transmitting X-rays through an object;
providing a scintillator for converting the transmitted X-rays into visible light photons;
providing an optical device for transmitting the visible light photons to a capturing device; and
providing a capturing device for creating a digital image from the visible light photons.

12. The method of claim 11 wherein said method further includes:
aligning said X-ray source, said scintillator, optical device and capturing device inline with one another.

13. The method of claim 11 wherein said step of providing an optical device includes:
a lens.

14. The method of claim 11 wherein said step of providing an optical device includes:
an optical fiber.

15. The method of claim 11 wherein said method further includes:
imaging an object greater in size than said capturing device.

16. The method of claim 11 wherein said step of providing a capturing device further includes:
an amorphous silicon detector plate.
